(19) United States
(12) Patent Application Publication
(10) Pub. No.: US 2026/0031029 A1
(43) Pub. Date: Jan. 29, 2026

(54) PIXEL CIRCUIT, DISPLAY DEVICE INCLUDING THE PIXEL CIRCUIT, AND ELECTRONIC DEVICE INCLUDING THE DISPLAY DEVICE

(71) Applicant: Samsung Display Co., Ltd., Yongin-Si (KR)

(72) Inventors: HYUNJOON KIM, Yongin-si (KR); YOUNGWAN SEO, Yongin-si (KR); JUNGHWAN HWANG, Yongin-si (KR)

(21) Appl. No.: 19/277,454

(22) Filed: Jul. 23, 2025

(30) Foreign Application Priority Data
Jul. 26, 2024 (KR) 10-2024-0099232
Mar. 6, 2025 (KR) 10-2025-0028865

(51) Int. Cl. G09G 3/32; G09G 3/20

(52) U.S. Cl. CPC G09G 3/32; G09G 3/2007; G09G 2300/0465; G09G 2300/0819; G09G 2300/0842; G09G 2310/08; G09G 2320/02; G09G 2320/045

(57) ABSTRACT

A pixel circuit may include a first transistor including a control electrode connected to a first node, a first electrode receiving a first power supply voltage, and a second electrode connected to a second node, a second transistor including a control electrode receiving a writing gate signal, a first electrode receiving a data voltage, and a second electrode connected to a third node, a third transistor including a control electrode receiving a compensation gate signal, a first electrode connected to the first node, and a second electrode connected to the second node, a fourth transistor including a control electrode receiving an initialization gate signal, a first electrode connected to the second node, and a second electrode receiving an initialization voltage, a holding capacitor including a first electrode connected to the third node and a second electrode connected to the first node, and a light emitting element.

### CROSS-REFERENCE TO RELATED APPLICATION(S)

This application claims priority under 35 USC § 119 to Korean Patent Application No. 10-2024-0099232 filed on Jul. 26, 2024 and Korean Patent Application No. 10-2025-0028865 filed on Mar. 6, 2025, in the Korean Intellectual Property Office (KIPO), the entire disclosure of which is incorporated by reference herein.

### BACKGROUND

### 1. Field

Embodiments of the present disclosure relate to a pixel circuit, a display device including the pixel circuit, and an electronic device including the display device.

### 2. Description of the Related Art

A display device may include a display panel and a display panel driver. The display panel may include gate lines, data lines, and pixel circuits. The display panel driver may include a gate driver providing gate signals to the gate lines, a data driver providing data voltages to the data lines, and a driving controller controlling the gate driver and the data driver.

Generally, the pixel circuit may include a source follower structure to compensate for a shift of a threshold voltage of a driving transistor included in the pixel circuit caused by degradation of the pixel circuit. In addition, a parasitic capacitor may be formed by a light emitting element included in the pixel circuit. A capacitance of the parasitic capacitor may vary due to the degradation of the pixel circuit. As the capacitance of the parasitic capacitor varies, deviation may occur in a threshold voltage compensation value by the source follower structure, and the pixel circuit may not emit a light at an accurate target luminance. In addition, when the pixel circuit includes the source follower structure, a threshold voltage compensation time of the driving transistor may be insufficient. Accordingly, the threshold voltage compensation of the driving transistor may be insufficient in the pixel circuit including the source follower structure, and thus the pixel circuit including the source follower structure may not emit a light at an accurate target luminance.

Recently, a display device for providing a virtual reality (VR) or an augmented reality (AR) is highlighted. For this purpose, a high PPI (Pixels Per Inch) and a high resolution are required for the display device. However, the pixel circuit including the source follower structure has limitations in implementing the display device having the high PPI and the high resolution.

### SUMMARY

A feature of the present disclosure is to provide a pixel circuit having a high PPI and a high resolution.

Another feature of the present disclosure is to provide a display device including the pixel circuit.

Still another feature of the present disclosure is to provide an electronic device including the display device.

However, features of the present disclosure are not limited to the above features, and may be variously extended without departing from the spirit and scope of the present disclosure.

According to embodiments, a pixel circuit may include a first transistor including a control electrode connected to a first node, a first electrode configured to receive a first power supply voltage, and a second electrode connected to a second node, a second transistor including a control electrode configured to receive a writing gate signal, a first electrode configured to receive a data voltage, and a second electrode connected to a third node, a third transistor including a control electrode configured to receive a compensation gate signal, a first electrode connected to the first node, and a second electrode connected to the second node, a fourth transistor including a control electrode configured to receive an initialization gate signal, a first electrode connected to the second node, and a second electrode configured to receive an initialization voltage, a holding capacitor including a first electrode connected to the third node and a second electrode connected to the first node, and a light emitting element including an anode connected to the second node and a cathode configured to receive a second power supply voltage.

In an embodiment, the pixel circuit may be configured to operate sequentially in a first period for initializing the first node, the second node, and the third node, in a second period for compensating for a threshold voltage of the first transistor, in a third period for transmitting the data voltage to the third node, in a fourth period for initializing the anode of the light emitting element, and in a fifth period for allowing the light emitting element to emit a light at a luminance corresponding to the data voltage.

In an embodiment, in the first period, the writing gate signal may have an activation level, the compensation gate signal may have an activation level, the initialization gate signal may have an activation level, the data voltage may have a first data voltage level, and the first power supply voltage applied to the first transistor may have a first power supply voltage level.

In an embodiment, in the second period, the writing gate signal may have the activation level, the compensation gate signal may have the activation level, the initialization gate signal may have a deactivation level, the data voltage may have the first data voltage level, and the first power supply voltage may have a second power supply voltage level higher than the first power supply voltage level.

In an embodiment, the data voltage having the first data voltage level may correspond to a minimum grayscale.

In an embodiment, in the third period, the writing gate signal may have the activation level, the compensation gate signal may have the activation level, the initialization gate signal may have the deactivation level, the data voltage may have a second data voltage level corresponding to a target luminance, and the first power supply voltage may have the second power supply voltage level.

In an embodiment, in the fourth period, the writing gate signal may have a deactivation level, the compensation gate signal may have a deactivation level, the initialization gate signal may have the activation level, the data voltage may have a third data voltage level, and the first power supply voltage may have the second power supply voltage level.

In an embodiment, in the fifth period, the writing gate signal may have the activation level, the compensation gate signal may have the deactivation level, the initialization gate signal may have the deactivation level, the data voltage may have the third data voltage level, and the first power supply voltage may have the second power supply voltage level.

In an embodiment, the data voltage having the third data voltage level may be a reference voltage.

According to embodiments, a display device may include a display panel including a pixel circuit and a display panel driver configured to drive the display panel. The pixel circuit may include a first transistor including a control electrode connected to a first node, a first electrode configured to receive a first power supply voltage, and a second electrode connected to a second node, a second transistor including a control electrode configured to receive a writing gate signal, a first electrode configured to receive a data voltage, and a second electrode connected to a third node, a third transistor including a control electrode configured to receive a compensation gate signal, a first electrode connected to the first node, and a second electrode connected to the second node, a fourth transistor including a control electrode configured to receive an initialization gate signal, a first electrode connected to the second node, and a second electrode configured to receive an initialization voltage, a holding capacitor including a first electrode connected to the third node and a second electrode connected to the first node, and a light emitting element including an anode connected to the second node and a cathode configured to receive a second power supply voltage.

In an embodiment, the pixel circuit may be configured to operate sequentially in a first period for initializing the first node, the second node, and the third node, in a second period for compensating for a threshold voltage of the first transistor, in a third period for transmitting the data voltage to the third node, in a fourth period for initializing the anode of the light emitting element, and in a fifth period for allowing the light emitting element to emit a light at a luminance corresponding to the data voltage.

In an embodiment, in the first period, the writing gate signal may have an activation level, the compensation gate signal may have an activation level, the initialization gate signal may have an activation level, the data voltage may have a first data voltage level, and the first power supply voltage applied to the first transistor may have a first power supply voltage level.

In an embodiment, in the second period, the writing gate signal may have the activation level, the compensation gate signal may have the activation level, the initialization gate signal may have a deactivation level, the data voltage may have the first data voltage level, and the first power supply voltage may have a second power supply voltage level higher than the first power supply voltage level.

In an embodiment, in the third period, the writing gate signal may have the activation level, the compensation gate signal may have the activation level, the initialization gate signal may have the deactivation level, the data voltage may have a second data voltage level corresponding to a target luminance, and the first power supply voltage may have the second power supply voltage level.

In an embodiment, in the fourth period, the writing gate signal may have a deactivation level, the compensation gate signal may have a deactivation level, the initialization gate signal may have the activation level, the data voltage may have a third data voltage level, and the first power supply voltage may have the second power supply voltage level.

In an embodiment, in the fifth period, the writing gate signal may have the activation level, the compensation gate signal may have the deactivation level, the initialization gate signal may have the deactivation level, the data voltage may have the third data voltage level, and the first power supply voltage may have the second power supply voltage level.

In an embodiment, pixel circuits including the pixel circuit included in the display panel may be connected in common to a first global signal line and the pixel circuits may be configured to simultaneously receive the compensation gate signal through the first global signal line.

In an embodiment, the pixel circuits included in the display panel may be connected in common to a second global signal line and wherein the pixel circuits may be configured to simultaneously receive the initialization gate signal through the second global signal line.

According to embodiments, an electronic device may include one or more processors configured to provide an input control signal and input image data, a memory device configured to store data information for an operation of the processor, a display panel including a pixel circuit, and a display panel driver configured to drive the display panel based on the input control signal and the input image data. The pixel circuit may include a first transistor including a control electrode connected to a first node, a first electrode configured to receive a first power supply voltage, and a second electrode connected to a second node, a second transistor including a control electrode configured to receive a writing gate signal, a first electrode configured to receive a data voltage, and a second electrode connected to a third node, a third transistor including a control electrode configured to receive a compensation gate signal, a first electrode connected to the first node, and a second electrode connected to the second node, a fourth transistor including a control electrode configured to receive an initialization gate signal, a first electrode connected to the second node, and a second electrode configured to receive an initialization voltage, a holding capacitor including a first electrode connected to the third node and a second electrode connected to the first node, and a light emitting element including an anode connected to the second node and a cathode configured to receive a second power supply voltage.

In an embodiment, pixel circuits including the pixel circuit included in the display panel may be connected in common to a first global signal line, the pixel circuits may be configured to simultaneously receive the compensation gate signal through the first global signal line, the pixel circuits may be connected in common to a second global signal line, and the pixel circuits may be configured to simultaneously receive the initialization gate signal through the second global signal line.

Therefore, as the pixel circuit includes fewer transistors and capacitors than a conventional pixel circuit including five or more transistors and one or more capacitors, an area occupied by a single pixel circuit on the display panel may be decreased, and thus an integration density of the pixel circuit may be increased.

In addition, the pixel circuits are connected in common to the first global signal line, the pixel circuits simultaneously receive the compensation gate signal through the first global signal line, and the pixel circuits are connected in common to the second global signal line, and the pixel circuits simultaneously receive the initialization gate signal through the second global signal line, so that additional scan drivers for outputting the compensation gate signal which is differently provided for each pixel row and the initialization gate signal which is differently provided for each pixel row may be not required. Accordingly, dead space and power consumption of the display device may be decreased. As the dead space of the display device is decreased, the integration density of the pixel circuit may be increased.

As the integration density of the pixel circuit is increased, the display device may have the high PPI and the high resolution, and display quality of the display device may be improved.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display device according to embodiments.

FIG. 2 is a circuit diagram illustrating an embodiment of a pixel circuit included in a display panel included in the display device of FIG. 1.

FIG. 3A is a diagram illustrating an operation in which a compensation gate signal and an initialization gate signal are applied to the pixel circuit of FIG. 2.

FIG. 3B is a diagram illustrating an operation in which a writing gate signal is applied to the pixel circuit of FIG. 2.

FIG. 4 is a timing diagram for describing an operation of the pixel circuit of FIG. 2.

FIG. 5 is a circuit diagram illustrating that the pixel circuit of FIG. 2 operates in a first period in FIG. 4.

FIG. 6 is a circuit diagram illustrating that the pixel circuit of FIG. 2 operates in a second period in FIG. 4.

FIG. 7 is a circuit diagram illustrating that the pixel circuit of FIG. 2 operates in a third period in FIG. 4.

FIG. 8 is a circuit diagram illustrating that the pixel circuit of FIG. 2 operates in a fourth period in FIG. 4.

FIG. 9 is a circuit diagram illustrating that the pixel circuit of FIG. 2 operates in a fifth period in FIG. 4.

FIG. 10 is a circuit diagram illustrating an embodiment of a pixel circuit included in the display panel included in the display device of FIG. 1.

FIG. 11 is a timing diagram for describing an operation of the pixel circuit of FIG. 10.

FIG. 12 is a block diagram illustrating an electronic device according to embodiments.

FIG. 13 is a schematic diagram illustrating the electronic device of FIG. 12.

### DETAILED DESCRIPTION OF THE EMBODIMENTS

Hereinafter, display devices in accordance with embodiments will be described in more detail with reference to the accompanying drawings. The same reference numerals are used for the same components in the drawings, and redundant descriptions of the same components will be omitted.

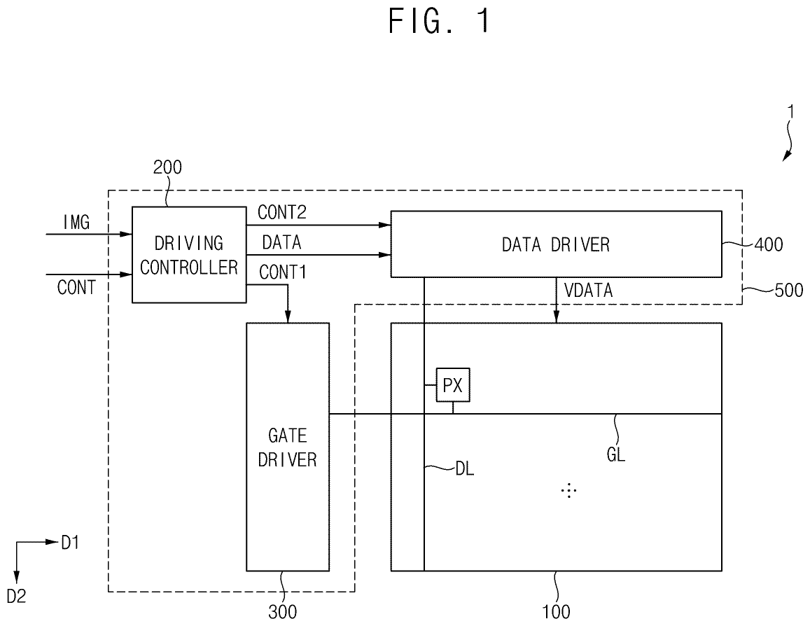

FIG. 1 is a block diagram illustrating a display device 1 according to embodiments.

Referring to FIG. 1, the display device 1 may include a display panel 100 and a display panel driver 500. The display panel driver 500 may include a driving controller 200, a gate driver 300, and a data driver 400.

For example, the driving controller 200 and the data driver 400 may be integrated into a single chip. A driving module including the driving controller 200 and the data driver 400 which are integrated the single chip may be referred to as a timing controller embedded data driver (TED).

The display panel 100 may have a display region on which an image is displayed and a peripheral region adjacent to the display region. For example, the peripheral region may be referred to as a bezel.

The display panel 100 may include gate lines GL, data lines DL, and pixel circuits PX. The gate lines GL may extend in a first direction D1, and the data lines DL may extend in a second direction D2 crossing the first direction D1.

In an embodiment, the pixel circuit PX may include first to fourth transistors, a holding capacitor, and a light emitting element. The number of the transistors and the number of the capacitors included in the pixel circuit PX may be decreased compared to a conventional pixel circuit including five or more transistors and one or more capacitors. As the number of the transistors and the number of the capacitors included in the pixel circuit PX are decreased, an area occupied by a single pixel circuit PX on the display panel 100 may be decreased. As the area occupied by the single pixel circuit PX on the display panel 100 is decreased, an integration density of the pixel circuit PX may be increased. As the integration density of the pixel circuit PX is increased, the display device 1 may have a high PPI and a high resolution. Accordingly, display quality of the display device 1 may be improved.

In an embodiment, the pixel circuit PX may include a driving transistor and a compensation transistor. The compensation transistor may diode-connect a control electrode of the driving transistor and a second electrode of the driving transistor in response to a compensation gate signal having an activation level. A threshold voltage of the driving transistor may be compensated for through a diode-connection. As the threshold voltage of the driving transistor is compensated for through the diode-connection, the threshold voltage of the driving transistor may be accurately compensated for regardless of degradation of a parasitic capacitor of the light emitting element. That is, even if the parasitic capacitor of the light emitting element is degraded, the threshold voltage of the driving transistor may be accurately compensated for. As the threshold voltage of the driving transistor is accurately compensated for, the pixel circuit PX may emit a light at an accurate target luminance. Accordingly, the display quality of the display device 1 may be improved.

In an embodiment, the pixel circuits PX included in the display panel 100 may be connected in common to a first global signal line. As the pixel circuits PX are connected in common to the first global signal line, the pixel circuits PX may simultaneously receive the compensation gate signal through the first global signal line. In addition, the pixel circuits PX included in the display panel 100 may be connected in common to a second global signal line. As the pixel circuits PX are connected in common to the second global signal line, the pixel circuits PX may simultaneously receive an initialization gate signal through the second global signal line.

As the pixel circuits PX simultaneously receive the compensation gate signal through the first global signal line, an additional scan driver for generating and outputting the compensation gate signal which is differently provided for each pixel row may be not required. In addition, as the pixel circuits PX simultaneously receive the initialization gate signal through the second global signal line, an additional scan driver for generating and outputting the initialization gate signal which is differently provided for each pixel row may be not required. As the additional scan drivers are not required, dead space and power consumption of the display device 1 may be decreased. In addition, as the dead space of the display device 1 is decreased, the number of the pixel circuits PX included in the display panel 100 may be increased. That is, an integration density of the pixel circuit PX may be increased. As the integration density of the pixel circuit PX is increased, the display device 1 may have the high PPI and the high resolution. Accordingly, the display quality of the display device 1 may be improved.

The driving controller 200 may receive input image data IMG and an input control signal CONT from an external device. For example, the input image data IMG may include red image data, green image data and blue image data. In some embodiments, the input image data IMG may further include white image data. In another example, the input image data IMG may include magenta image data, yellow image data and cyan image data. The input control signal CONT may include a master clock signal and a data enable signal. The input control signal CONT may further include a vertical synchronizing signal and a horizontal synchronizing signal.

The driving controller 200 may generate a gate control signal CONT1, a data control signal CONT2, and a data signal DATA based on the input image data IMG and the input control signal CONT.

The driving controller 200 may generate the gate control signal CONT1 for controlling an operation of the gate driver 300 based on the input control signal CONT, and may output the gate control signal CONT1 to the gate driver 300. The gate control signal CONT1 may include a vertical start signal and a gate clock signal.

The driving controller 200 may generate the data control signal CONT2 for controlling an operation of the data driver 400 based on the input control signal CONT, and may output the data control signal CONT2 to the data driver 400. The data control signal CONT2 may include a horizontal start signal and a load signal.

The driving controller 200 may generate the data signal DATA based on the input image data IMG. The driving controller 200 may output the data signal DATA to the data driver 400.

The gate driver 300 may generate gate signals transmitted to the pixel circuits PX through the gate lines GL in response to the gate control signal CONT1 received from the driving controller 200. The gate driver 300 may output the gate signals through the gate lines GL. For example, the gate driver 300 may be mounted on the peripheral region of the display panel 100.

The data driver 400 may receive the data control signal CONT2 and the data signal DATA from the driving controller 200. The data driver 400 may convert the data signal DATA in a digital form into data voltages in an analog form. The data driver 400 may output the data voltages through the data lines DL.

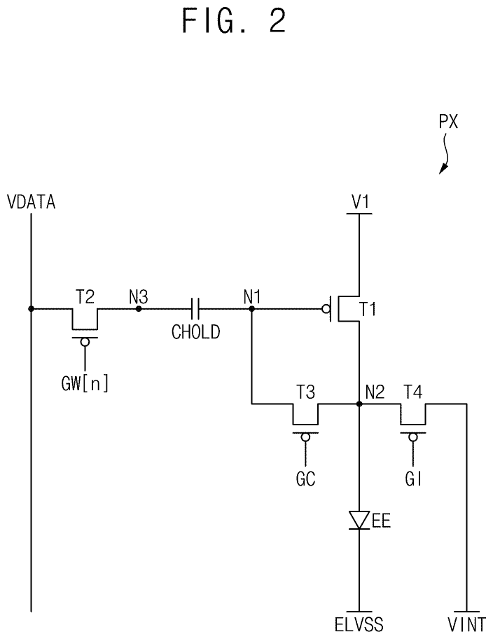

FIG. 2 is a circuit diagram illustrating an embodiment of the pixel circuit PX included in the display panel 100 included in the display device 1 of FIG. 1.

Referring to FIG. 2, the pixel circuit PX may include first to fourth transistors T1 to T4, a holding capacitor CHOLD, and a light emitting element EE.

The display panel 100 may include first to m-th pixel rows extending in the first direction D1, where m is an integer greater than or equal to 2. Each of the first to m-th pixel rows may include the pixel circuits PX. For convenience of explanation, it is assumed below that the pixel circuit PX illustrated in FIG. 2 is included in a n-th pixel row, where n is an integer greater than or equal to 1 and less than or equal to m.

The first transistor T1 may include a control electrode connected to a first node N1, a first electrode receiving a first power supply voltage V1, and a second electrode connected to a second node N2. The first transistor T1 may generate a driving current based on a data voltage VDATA. The first transistor T1 may be referred to as the driving transistor.

The second transistor T2 may include a control electrode receiving a n-th writing gate signal GW[n], a first electrode receiving the data voltage VDATA, and a second electrode connected to a third node N3.

The third transistor T3 may include a control electrode receiving a compensation gate signal GC, a first electrode connected to the first node N1, and a second electrode connected to the second node N2. The third transistor T3 may be referred to as the compensation transistor.

The control electrode of the third transistor T3 may be connected to the first global signal line. The control electrode of the third transistor T3 may receive the compensation gate signal GC through the first global signal line.

The fourth transistor T4 may include a control electrode receiving an initialization gate signal GI, a first electrode connected to the second node N2, and a second electrode receiving an initialization voltage VINT.

The control electrode of the fourth transistor T4 may be connected to the second global signal line. That is, the control electrode of the fourth transistor T4 may receive the initialization gate signal GI through the second global signal line.

The holding capacitor CHOLD may include a first electrode connected to the third node N3 and a second electrode connected to the first node N1.

The light emitting element EE may include an anode connected to the second node N2 and a cathode receiving a second power supply voltage ELVSS.

The first to fourth transistors T1 to T4 may be implemented as P-channel metal oxide semiconductor (PMOS) transistors. When the first transistor T1 is implemented as the PMOS transistor, the driving current generated by the first transistor T1 may be increased compared to when it is implemented as an N-channel metal oxide semiconductor (NMOS) transistor. As the driving current generated by the first transistor T1 is increased, a stability of the pixel circuit PX may be increased.

The number of the transistors and the number of the capacitors included in the pixel circuit PX may be decreased compared to the conventional pixel circuit including five or more transistors and one or more capacitors. As the number of the transistors and the number of the capacitors included in the pixel circuit PX are decreased, the area occupied by the single pixel circuit PX on the display panel 100 may be decreased. As the area occupied by the single pixel circuit PX on the display panel 100 is decreased, the integration density of the pixel circuit PX may be increased. As the integration density of the pixel circuit PX is increased, the display device 1 may have the high PPI and the high resolution. Accordingly, the display quality of the display device 1 may be improved.

The third transistor T3 may diode-connect the first node N1 and the second node N2 in response to the compensation gate signal GC having the activation level. The threshold voltage of the first transistor T1 may be compensated for by the diode-connection. As the threshold voltage of the first transistor T1 is compensated for by the diode-connection, the threshold voltage of the first transistor T1 may be accurately compensated for regardless of the degradation of the parasitic capacitor of the light emitting element EE. That is, even if the parasitic capacitor of the light emitting element EE is degraded, the threshold voltage of the first transistor T1 may be accurately compensated for. As the threshold voltage of the first transistor T1 is accurately compensated for, the pixel circuit PX may emit a light at an accurate target luminance. Accordingly, the display quality of the display device 1 may be improved.

The pixel circuits PX included in the display panel 100 may be connected in common to the first global signal line. More particularly, the control electrode of the third transistor T3 included in each of the pixel circuits PX may be connected to the first global signal line. As the pixel circuits PX are connected in common to the first global signal line, the pixel circuits PX may simultaneously receive the compensation gate signal GC through the first global signal line. In addition, the pixel circuits PX included in the display panel 100 may be connected in common to the second global signal line. More particularly, the control electrode of the fourth transistor T4 included in each of the pixel circuits PX may be connected to the second global signal line. As the pixel circuits PX are connected in common to the second global signal line, the pixel circuits PX may simultaneously receive the initialization gate signal GI through the second global signal line.

Writing gate signals GW[1]-GW[m] may be provided differently for each pixel row. For example, the first writing gate signal GW[1] may be provided to the pixel circuit PX of a first pixel row through a first writing gate line. The second writing gate signal GW[2] may be provided to the pixel circuit PX of a second pixel row through a second writing gate line. In this way, the n-th writing gate signal GW[n] may be provided to the pixel circuit PX of the n-th pixel row through an n-th writing gate line.

As the pixel circuits PX simultaneously receive the compensation gate signal GC through the first global signal line, an additional scan driver for generating and outputting the compensation gate signal GC which is differently provided for each pixel row may be not required. In addition, as the pixel circuits PX simultaneously receive the initialization gate signal GI through the second global signal line, an additional scan driver for generating and outputting the initialization gate signal GI which is differently provided for each pixel row may be not required. As the additional scan drivers are not required, the dead space and the power consumption of the display device 1 may be decreased. In addition, as the dead space of the display device 1 is decreased, the number of the pixel circuits PX included in the display panel 100 may be increased. That is, the integration density of the pixel circuit PX may be increased. As the integration density of the pixel circuit PX is increased, the display device 1 may have the high PPI and the high resolution. Accordingly, the display quality of the display device 1 may be improved.

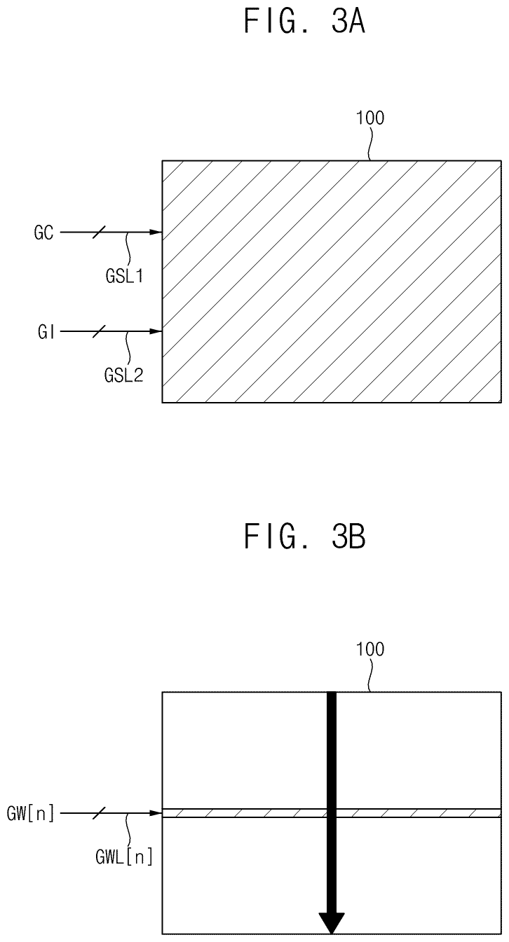

FIG. 3A is a diagram illustrating an operation in which the compensation gate signal GC and the initialization gate signal GI are applied to the pixel circuit PX of FIG. 2. FIG. 3B is a diagram illustrating an operation in which the writing gate signal GW[n] is applied to the pixel circuit PX of FIG. 2.

Referring to FIGS. 3A and 3B, the compensation gate signal GC may be provided simultaneously to the pixel circuits PX included in the display panel 100. In addition, the initialization gate signal GI may be provided simultaneously to the pixel circuits PX included in the display panel 100. The writing gate signals GW[1]-GW[m] may be provided differently for each pixel row through the writing gate line.

The pixel circuits PX included in the display panel 100 may be connected in common to the first global signal line GSL1 which transmits the compensation gate signal GC. As the pixel circuits PX are connected in common to the first global signal line GSL1, the pixel circuits PX may simultaneously receive the compensation gate signal GC.

In addition, the pixel circuits PX included in the display panel 100 may be connected in common to the second global signal line GSL2 which transmits the initialization gate signal GI. As the pixel circuits PX are connected in common to the second global signal line GSL2, the pixel circuits PX may simultaneously receive the initialization gate signal GI.

In an embodiment, the writing gate signals GW[1]-GW[m] may be provided differently for each row through writing gate lines.

For example, the first writing gate signal GW[1] may be provided to the pixel circuits PX of the first pixel row through the first writing gate line. The second writing gate signal GW[2] may be provided to the pixel circuits PX of the second pixel row through the second writing gate line. In this way, the n-th writing gate signal GW[n] may be provided to the pixel circuits PX of the n-th pixel row through the n-th writing gate line GWL[n].

For example, the writing gate signals GW[1]-GW[m] having an activation level may be sequentially provided to the pixel rows. The first writing gate signal GW[1] having the activation level may be provided to the first writing gate line, and then the second writing gate signal GW[2] having the activation level may be provided to the second writing gate line. In addition, the second writing gate signal GW[2] having the activation level may be provided to the second writing gate line, and then a third writing gate signal GW[3] having the activation level may be provided to a third writing gate line. In this way, a (m−1)-th writing gate signal GW[m−1] having the activation level may be provided to a (m−1)-th writing gate line, and then an m-th writing gate signal GW[m] having the activation level may be provided to an m-th writing gate line.

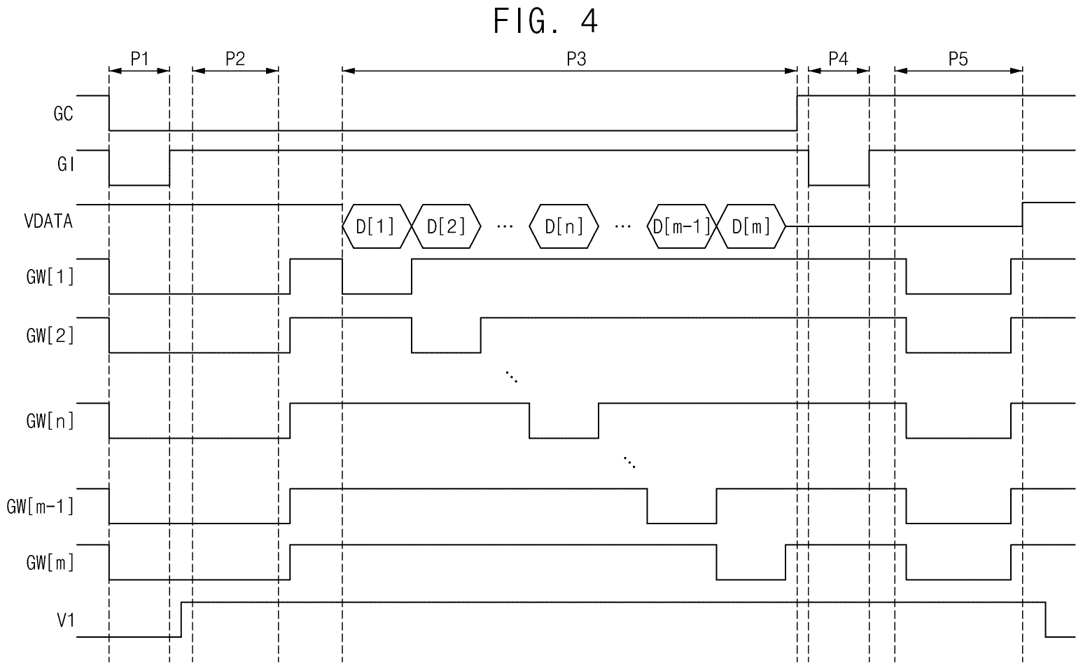

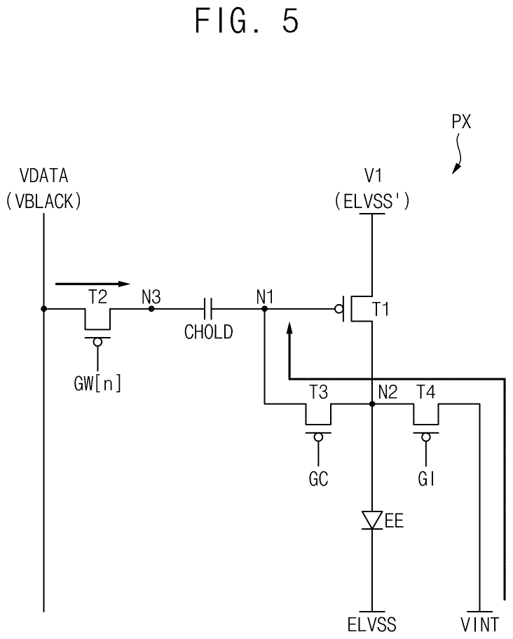

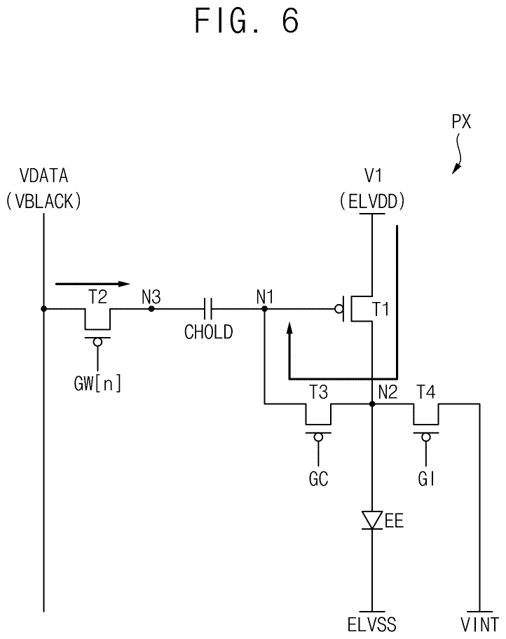

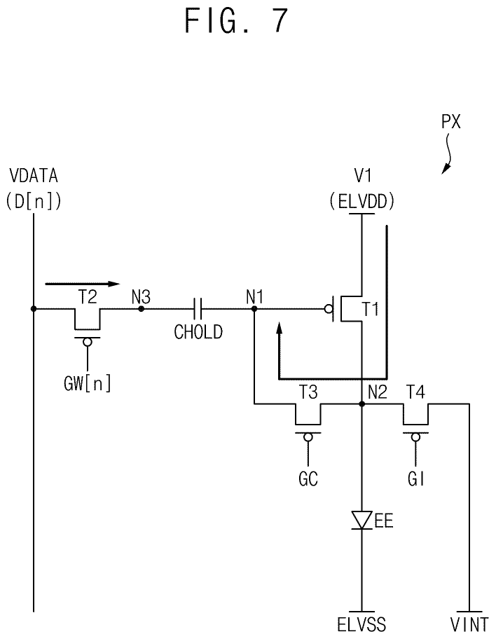

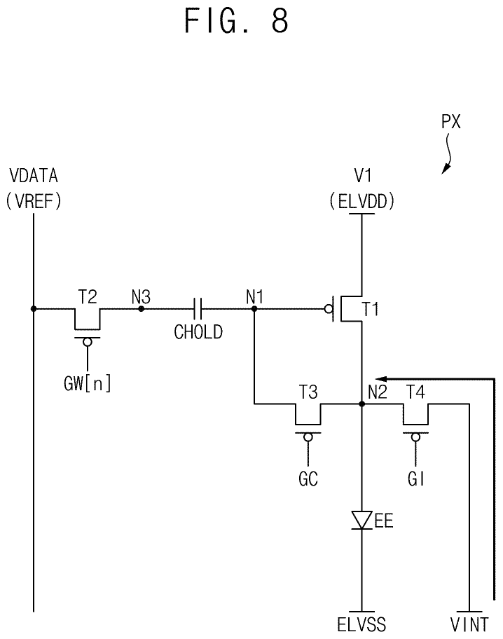

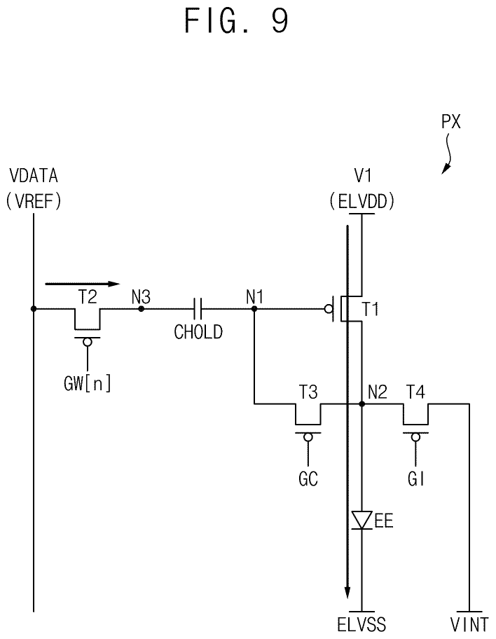

FIG. 4 is a timing diagram for describing an operation of the pixel circuit PX of FIG. 2. FIG. 5 is a circuit diagram illustrating that the pixel circuit PX of FIG. 2 operates in a first period P1 in FIG. 4. FIG. 6 is a circuit diagram illustrating that the pixel circuit PX of FIG. 2 operates in a second period P2 in FIG. 4. FIG. 7 is a circuit diagram illustrating that the pixel circuit PX of FIG. 2 operates in a third period P3 in FIG. 4. FIG. 8 is a circuit diagram illustrating that the pixel circuit PX of FIG. 2 operates in a fourth period P4 in FIG. 4. FIG. 9 is a circuit diagram illustrating that the pixel circuit PX of FIG. 2 operates in a fifth period P5 in FIG. 4.

Referring to FIG. 4, periods in which the pixel circuit PX operates may include the first period P1, the second period P2, the third period P3, the fourth period P4, and the fifth period P5. As the first to fourth transistors T1 to T4 are implemented as the PMOS transistors, the activation level of the compensation gate signal GC may be a low level and a deactivation level of the compensation gate signal GC may be a high level higher than the low level. In addition, an activation level of the initialization gate signal GI may be the low level and a deactivation level of the initialization gate signal GI may be the high level. Furthermore, the activation level of the writing gate signals GW[1]-GW[m] may be the low level and a deactivation level of the writing gate signals GW[1]-GW[m] may be the high level.

The first period P1 may be a first initialization period in which the first to third nodes N1 to N3 are initialized. The second period P2 may be a compensation period in which the threshold voltage of the first transistor T1 is compensated for. The third period P3 may be a data transmission period in which the data voltage is transmitted to the third node N3. The fourth period P4 may be a second initialization period in which the anode of the light emitting element EE is initialized. The fifth period P5 may be an emission period in which the light emitting element EE emits a light.

The first to m-th writing gate signals GW[1] to GW[m] may have the activation level in the first period P1. The first to m-th writing gate signals GW[1] to GW[m] may have the activation level in the second period P2. The first to m-th writing gate signals GW[1] to GW[m] may have the deactivation level in the fourth period P4. The first to m-th writing gate signals GW[1] to GW[m] may have the activation level in the fifth period P5.

In an embodiment, the writing gate signals GW[1]-GW[m] having the activation level may be sequentially provided to each pixel row through the writing gate lines in the third period P3. For example, the first writing gate signal GW[1] having the activation level may be provided to the first pixel row in the third period P3. When the first writing gate signal GW[1] has the activation level, the second to m-th writing gate signals GW[2] to GW[m] may have the deactivation level. The first writing gate signal GW[1] having the activation level may be provided to the first pixel row, and then the second writing gate signal GW[2] having the activation level may be provided to the second pixel row. When the second writing gate signal GW[2] has the activation level, the first writing gate signal GW[1] and the third to m-th writing gate signals GW[3] to GW[m] may have the deactivation level. In this way, the (m−1)-th writing gate signal GW[m−1] having the activation level may be provided to the (m−1)-th pixel row, and then the m-th writing gate signal GW[m] having the activation level may be provided to the m-th pixel row. When the m-th writing gate signal GW[m] has the activation level, the first to (m−1)-th writing gate signals GW[1] to GW[m−1] may have the deactivation level.

For convenience of explanation, it will be described with respect to the pixel circuit PX included in the n-th pixel row receiving the n-th writing gate signal GW[n].

Referring to FIGS. 4 and 5, the compensation gate signal GC may have the activation level in the first period P1. The initialization gate signal GI may have the activation level. The n-th writing gate signal GW[n] may have the activation level. In addition, the data voltage may have a first data voltage level VBLACK. The data voltage VDATA having the first data voltage level VBLACK may correspond to a minimum grayscale. That is, the data voltage VDATA having the first data voltage level VBLACK may correspond to a black luminance. In addition, the first power supply voltage V1 may have a first power supply voltage level ELVSS′. The first power supply voltage level ELVSS' may be the same as a level of the second power supply voltage ELVSS.

The second transistor T2 may be turned on in response to the n-th writing gate signal GW[n] having the activation level. The third transistor T3 may be turned on in response to the compensation gate signal GC having the activation level. The fourth transistor T4 may be turned on in response to the initialization gate signal GI having the activation level.

The second transistor T2, which is turned on, may transmit the data voltage VDATA having the first data voltage level VBLACK to the third node N3. Accordingly, the third node N3 may be initialized with the data voltage VDATA having the first data voltage level VBLACK.

The fourth transistor T4, which is turned on, may transmit the initialization voltage VINT to the second node N2. Accordingly, the second node N2 may be initialized with the initialization voltage VINT.

The third transistor T3, which is turned on, may transmit the initialization voltage VINT of the second node N2 to the first node N1. Accordingly, the first node N1 may be initialized with the initialization voltage VINT.

The control electrode of the first transistor T1 may have the initialization voltage VINT, and the first electrode of the first transistor T1 may have the first power supply voltage V1 having the first power supply voltage level ELVSS′.

A magnitude of a difference between the initialization voltage VINT and the first power supply voltage V1 having the first power supply voltage level ELVSS' may be less than a magnitude of the threshold voltage of the first transistor T1. Accordingly, a magnitude of a difference between the voltage of the control electrode of the first transistor T1 and a voltage of the first electrode of the first transistor T1 may be less than the magnitude of the threshold voltage of the first transistor T1. As the magnitude of the difference between the voltage of the control electrode of the first transistor T1 and the voltage of the first electrode of the first transistor T1 is less than the magnitude of the threshold voltage of the first transistor T1, the first transistor T1 may be turned off.

The pixel circuits PX may simultaneously receive the compensation gate signal GC having the activation level through the first global signal line GSL1 (see FIG. 3A) in the first period P1. The pixel circuits PX may simultaneously receive the initialization gate signal GI having the activation level through the second global signal line GSL2 (see FIG. 3A). The first to m-th writing gate signals GW[1] to GW[m] may have the activation level. As the compensation gate signal GC has the activation level, the initialization gate signal GI has the activation level, and the first to m-th writing gate signals GW[1] to GW[m] have the activation level, the pixel circuits PX may simultaneously perform an initialization operation which initializes the first node N1, may simultaneously perform an initialization operation which initializes the second node N2, and may simultaneously perform an initialization operation which initializes the third node N3.

Referring to FIGS. 4 and 6, the compensation gate signal GC may have the activation level in the second period P2. The initialization gate signal GI may have the deactivation level. The n-th writing gate signal GW[n] may have the activation level. In addition, the data voltage may have the first data voltage level VBLACK. In addition, the first power supply voltage V1 may have a second power supply voltage level ELVDD. The second power supply voltage level ELVDD may be higher than the level of the second power supply voltage ELVSS.

The second transistor T2 may be turned on in response to the n-th writing gate signal GW[n] having the activation level. The third transistor T3 may be turned on in response to the compensation gate signal GC having the activation level. The fourth transistor T4 may be turned off in response to the initialization gate signal GI having the deactivation level.

The second transistor T2, which is turned on, may transmit the data voltage VDATA having the first data voltage level VBLACK to the third node N3. Accordingly, the third node N3 may maintain the data voltage VDATA having the first data voltage level VBLACK.

The control electrode of the first transistor T1 may have the initialization voltage VINT and the first electrode of the first transistor T1 may have the first power supply voltage V1 having the second power supply voltage level ELVDD.

A magnitude of a difference between the initialization voltage VINT and the first power supply voltage V1 having the second power supply voltage level ELVDD may be greater than the magnitude of the threshold voltage of the first transistor T1. Accordingly, the magnitude of the difference between the voltage of the control electrode of the first transistor T1 and the voltage of the first electrode of the first transistor T1 may be greater than the magnitude of the threshold voltage of the first transistor T1. As the magnitude of the difference between the voltage of the control electrode of the first transistor T1 and the voltage of the first electrode of the first transistor T1 is greater than the magnitude of the threshold voltage of the first transistor T1, the first transistor T1 may be turned on, and a voltage of the second node N2 may be increased.

The third transistor T3, which is turned on, may transmit the voltage of the second node N2 to the first node N1. As the voltage of the second node N2 is increased, a voltage of the first node N1 may be increased. That is, the voltage of the control electrode of the first transistor T1 may be increased.

When the magnitude of the difference between the voltage of the control electrode of the first transistor T1 and the voltage of the first electrode of the first transistor T1 becomes the same as the magnitude of the threshold voltage of the first transistor T1, the first transistor T1 may be turned off. When the first transistor T1 is turned off, the voltage of the first node N1 may be calculated by [Equation 1], “ELVDD+Vth”, where ELVDD denotes the first power supply voltage V1 having the second power supply voltage level ELVDD and Vth denotes the threshold voltage of the first transistor T1.

The holding capacitor CHOLD may store a difference between a voltage of the third node N3 and the voltage of the first node N1. A voltage stored in the holding capacitor CHOLD may be calculated by [Equation 2], “VBLACK−(ELVDD+Vth)”, where VBLACK denotes the data voltage VDATA having the first data voltage level VBLACK, ELVDD denotes the first power supply voltage V1 having the second power supply voltage level ELVDD, and Vth denotes the threshold voltage of the first transistor T1.

The pixel circuits PX may simultaneously receive the compensation gate signal GC having the activation level through the first global signal line GSL1 in the second period P2. The first to m-th writing gate signals GW[1] to GW[m] may have the activation level. As the compensation gate signal GC has the activation level and the first to m-th writing gate signals GW[1] to GW[m] have the activation level, the pixel circuits PX may simultaneously perform a compensation operation which compensates for the threshold voltage of the first transistor T1.

Referring to FIGS. 4 and 7, the compensation gate signal GC may have the activation level in the third period P3. The initialization gate signal GI may have the deactivation level. The n-th writing gate signal GW[n] may have the activation level. In addition, the data voltage VDATA may have a second data voltage level D[n]. The data voltage VDATA having the second data voltage level D[n] may correspond to the target luminance of the pixel circuit PX. In addition, the first power supply voltage V1 may have the second power supply voltage level ELVDD.

The second transistor T2 may be turned on in response to the n-th writing gate signal GW[n] having the activation level. The third transistor T3 may be turned on in response to the compensation gate signal GC having the activation level. The fourth transistor T4 may be turned off in response to the initialization gate signal GI having the deactivation level.

The second transistor T2, which is turned on, may transmit the data voltage VDATA having the second data voltage level D[n] to the third node N3. Accordingly, a level of the voltage of the third node N3 may be changed from the first data voltage level VBLACK to the second data voltage level D[n]. That is, the third node N3 may have the data voltage VDATA having the second data voltage level D[n].

As the level of the voltage of the third node N3 is changed, the voltage of the first node N1 may be changed by a coupling of the holding capacitor CHOLD. The voltage of the first node N1 may be calculated by [Equation 3], “ELVDD+Vth+(D[n]−VBLACK)”, where D[n] denotes the data voltage VDATA having the second data voltage level D[n], VBLACK denotes the data voltage VDATA having the first data voltage level VBLACK, ELVDD denotes the first power supply voltage V1 having the second power supply voltage level ELVDD, and Vth denotes the threshold voltage of the first transistor T1.

The voltage of the control electrode of the first transistor T1 may be same as the voltage of the first node N1. The first electrode of the first transistor T1 may have the first power supply voltage V1 having the second power supply voltage ELVDD.

A magnitude of a difference between the voltage of the first node N1 and the first power supply voltage V1 having the second power supply voltage level ELVDD may be greater than the magnitude of the threshold voltage of the first transistor T1. Accordingly, the magnitude of the difference between the voltage of the control electrode of the first transistor T1 and the voltage of the first electrode of the first transistor T1 may be greater than the magnitude of the threshold voltage of the first transistor T1. As the magnitude of the difference between the voltage of the control electrode of the first transistor T1 and the voltage of the first electrode of the first transistor T1 is greater than the magnitude of the threshold voltage of the first transistor T1, the first transistor T1 may be turned on, and a voltage of the second node N2 may be increased.

The third transistor T3, which is turned on, may transmit the voltage of the second node N2 to the first node N1. As the voltage of the second node N2 is increased, a voltage of the first node N1 may be increased. That is, the voltage of the control electrode of the first transistor T1 may be increased.

When the magnitude of the difference between the voltage of the control electrode of the first transistor T1 and the voltage of the first electrode of the first transistor T1 becomes the same as the magnitude of the threshold voltage of the first transistor T1, the first transistor T1 may be turned off. When the first transistor T1 is turned off, the voltage of the first node N1 may be calculated by the [Equation 1].

The first to m-th writing gate signals GW[1] to GW[m] may sequentially have the activation level in the third period P3. As the first to m-th writing gate signals GW[1] to GW[m] sequentially have the activation level, the data voltage VDATA having the second data voltage level D[n] may be sequentially transmitted to the third node N3.

Referring to FIGS. 4 and 8, the compensation gate signal GC may have the deactivation level in the fourth period P4. The initialization gate signal GI may have the activation level. The n-th writing gate signal GW[n] may have the deactivation level. In addition, the data voltage may have a third data voltage level VREF. In addition, the first power supply voltage V1 may have the second power supply voltage level ELVDD.

For example, the data voltage VDATA having the third data voltage level VREF may be a reference voltage. For example, the reference voltage may be less than the data voltage VDATA having the first data voltage level VBLACK corresponding to the minimum grayscale. For example, the reference voltage may be the same as the data voltage VDATA having the first data voltage level VBLACK corresponding to the minimum grayscale.

The second transistor T2 may be turned off in response to the n-th writing gate signal GW[n] having the deactivation level. The third transistor T3 may be turned off in response to the compensation gate signal GC having the deactivation level. The fourth transistor T4 may be turned on in response to the initialization gate signal GI having the activation level.

The fourth transistor T4, which is turned on, may transmit the initialization voltage VINT to the second node N2. Accordingly, the second node N2 may be initialized with the initialization voltage VINT. That is, the anode of the light emitting element EE may be initialized with the initialization voltage VINT.

The pixel circuits PX may simultaneously receive the initialization gate signal GI having the activation level through the second global signal line GSL2 (see FIG. 3A) in the fourth period P4. As the pixel circuits PX simultaneously receive the initialization gate signal GI having the activation level, the pixel circuits PX may simultaneously perform the initialization operation which initializes the second node N2. That is, the pixel circuits PX may simultaneously perform the initialization operation which initializes the anode of the light emitting element EE.

Referring to FIGS. 4 and 9, the compensation gate signal GC may have the deactivation level in the fifth period P5. The initialization gate signal GI may have the deactivation level. The n-th writing gate signal GW[n] may have the activation level. In addition, the data voltage may have the third data voltage level VREF. In addition, the first power supply voltage V1 may have the second power supply voltage level ELVDD.

The second transistor T2 may be turned on in response to the n-th writing gate signal GW[n] having the activation level. The third transistor T3 may be turned off in response to the compensation gate signal GC having the deactivation level. The fourth transistor T4 may be turned off in response to the initialization gate signal GI having the deactivation level.

The second transistor T2, which is turned on, may transmit the data voltage VDATA having the third data voltage level VREF to the third node N3. Accordingly, the level of the voltage of the third node N3 may be changed from the second data voltage level D[n] to the third data voltage level VREF. That is, the third node N3 may have the data voltage VDATA having the third data voltage level VREF.

As the level of the voltage of the third node N3 is changed, the voltage of the first node N1 may be changed by the coupling of the holding capacitor CHOLD. The voltage of the first node N1 may be calculated by [Equation 4], “ELVDD+Vth+(VREF−D[n])”, where D[n] denotes the data voltage VDATA having the second data voltage level D[n], VREF denotes the data voltage VDATA having the third data voltage level VREF, ELVDD denotes the first power supply voltage V1 having the second power supply voltage level ELVDD, and Vth denotes the threshold voltage of the first transistor T1.

The voltage of the control electrode of the first transistor T1 may be same as the voltage of the first node N1. The first electrode of the first transistor T1 may have the first power supply voltage V1 having the second power supply voltage ELVDD.

The magnitude of the difference between the voltage of the first node N1 and the first power supply voltage V1 having the second power supply voltage level ELVDD may be greater than the magnitude of the threshold voltage of the first transistor T1. Accordingly, the magnitude of the difference between the voltage of the control electrode of the first transistor T1 and the voltage of the first electrode of the first transistor T1 may be greater than the magnitude of the threshold voltage of the first transistor T1. As the magnitude of the difference between the voltage of the control electrode of the first transistor T1 and the voltage of the first electrode of the first transistor T1 is greater than the magnitude of the threshold voltage of the first transistor T1, the first transistor T1 may be turned on.

The first transistor T1, which is turned on, may generate the driving current based on the voltage of the control electrode of the first transistor T1 and the voltage of the first electrode of the first transistor T1.

The driving current may be calculated by [Equation 5], “Id=k*(Vsg+Vth)²”, where Id denotes the driving current, k denotes a constant value (e.g. a transconductance parameter of the first transistor T1), and Vsg denotes the difference between the voltage of the first electrode of the first transistor T1 and the voltage of the control electrode of the first transistor T1.

As the voltage of the first electrode of the first transistor T1 has the second power supply voltage level ELVDD and the voltage of the control electrode of the first transistor T1 is calculated by the [Equation 4], the difference between the voltage of the first electrode of the first transistor T1 and the voltage of the control electrode of the first transistor T1 may be calculated by [Equation 6], “Vsg=−Vth−(VREF−D[n])”, where Vsg denotes the difference between the voltage of the first electrode of the first transistor T1 and the voltage of the control electrode of the first transistor T1, Vth denotes the threshold voltage of the first transistor T1, VREF denotes the data voltage VDATA having the third data voltage level VREF, and D[n] denotes the data voltage having the second data voltage level D[n].

As the difference between the voltage of the first electrode of the first transistor T1 and the voltage of the control electrode of the first transistor T1 is calculated by the [Equation 6], the driving current may be calculated by [Equation 7], “Id=k*(VREF−D[n])²”, where ID denotes the driving current, k denotes the constant value (e.g. the transconductance parameter of the first transistor T1), Vth denotes the threshold voltage of the first transistor T1, VREF denotes the data voltage VDATA having the third data voltage level VREF, and D[n] denotes the data voltage VDATA having the second data voltage level D[n].

The driving current may be determined based on a difference between the data voltage VDATA having the third data voltage level VREF and the data voltage VDATA having the second data voltage level D[n] in the fifth period P5. The driving current may be proportional to the square of the difference between the data voltage VDATA having the third data voltage level VREF and the data voltage VDATA having the second data voltage level D[n].

The light emitting element EE may emit a light at the target luminance based on the driving current generated by the first transistor T1. In addition, the pixel circuits PX simultaneously receive the compensation gate signal GC, the pixel circuits PX simultaneously receive the initialization gate signal GI and the first to m-th writing gate signals GW[1] to GW[w] have the activation level, so that the pixel circuits PX included in the display panel 100 may simultaneously emit a light at the target luminance in the fifth period P5.

The number of the transistors and the number of the capacitors included in the pixel circuit PX may be decreased compared to the conventional pixel circuit including five or more transistors and one or more capacitors. As the number of the transistors and the number of the capacitors included in the pixel circuit PX are decreased, the area occupied by the single pixel circuit PX on the display panel 100 may be decreased. As the area occupied by the single pixel circuit PX on the display panel 100 is decreased, the integration density of the pixel circuit PX may be increased. As the integration density of the pixel circuit PX is increased, the display device 1 may have the high PPI and the high resolution. Accordingly, the display quality of the display device 1 may be improved.

In addition, the third transistor T3 may diode-connect the first node N1 and the second node N2 in response to the compensation gate signal having the activation level in the second period P2. The threshold voltage of the first transistor T1 may be compensated for by the diode-connection. As the threshold voltage of the first transistor T1 is compensated for by the diode-connection, the threshold voltage of the first transistor T1 may be accurately compensated for regardless of the degradation of the parasitic capacitor of the light emitting element EE. That is, even if the parasitic capacitor of the light emitting element EE is degraded, the threshold voltage of the first transistor T1 may be accurately compensated for. As the threshold voltage of the first transistor T1 is accurately compensated for, the pixel circuit PX may emit a light at an accurate target luminance. Accordingly, the display quality of the display device 1 may be improved.

As the pixel circuits PX simultaneously receive the compensation gate signal GC through the first global signal line GSL1, an additional scan driver for generating and outputting the compensation gate signal GC which is differently provided for each pixel row may be not required. In addition, as the pixel circuits PX simultaneously receive the initialization gate signal GI through the second global signal line GSL2, an additional scan driver for generating and outputting the initialization gate signal GI which is differently provided for each pixel row may be not required. As the additional scan drivers are not required, the dead space and the power consumption of the display device 1 may be decreased. In addition, as the dead space of the display device 1 is decreased, the number of the pixel circuits PX included in the display panel 100 may be increased. That is, the integration density of the pixel circuit PX may be increased. As the integration density of the pixel circuit PX is increased, the display device 1 may have the high PPI and the high resolution. Accordingly, the display quality of the display device 1 may be improved.

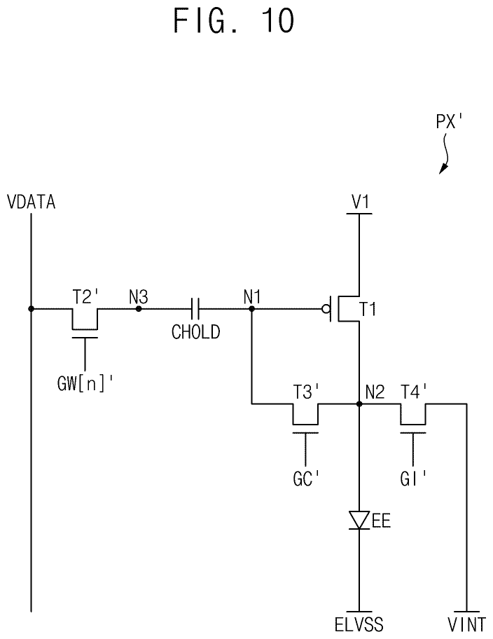

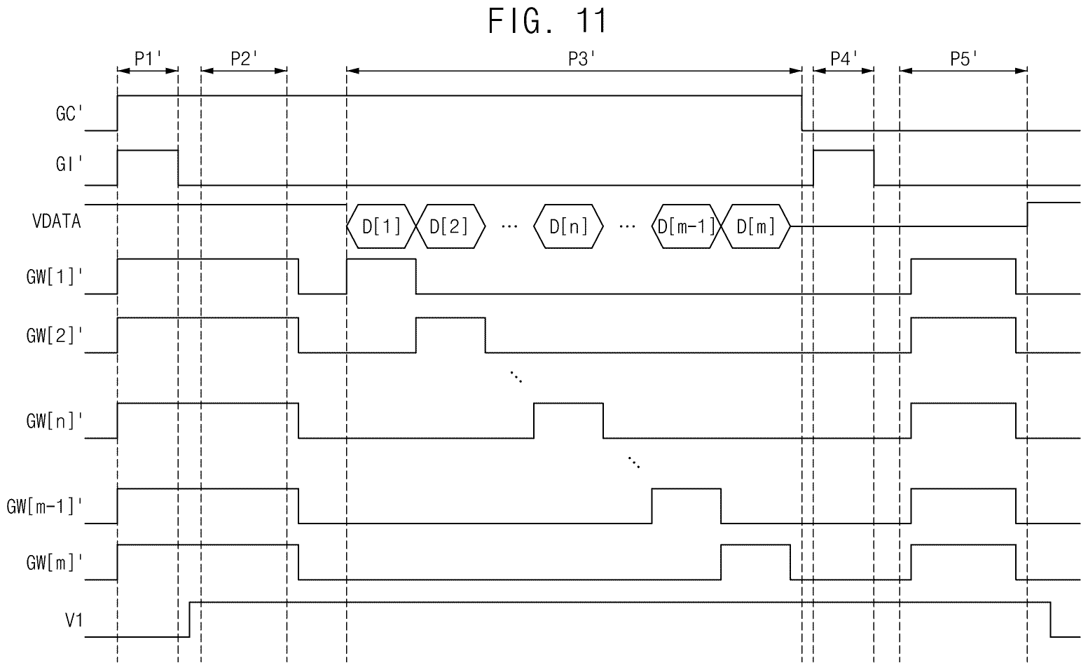

FIG. 10 is a circuit diagram illustrating an embodiment of a pixel circuit PX′ included in the display panel 100 included in the display device 1 of FIG. 1. FIG. 11 is a timing diagram for describing an operation of the pixel circuit PX′ of FIG. 10.

Referring to FIG. 10, the pixel circuit PX′ may include first to fourth transistors T1, T2′, T3′, and T4′, the holding capacitor CHOLD, and the light emitting element EE. The pixel circuit PX′ is substantially the same as the pixel circuit PX of FIG. 2 except for types of the second to fourth transistors T2′ to T4′. Thus, the same reference numerals will be used to refer to the same or like parts as those described in the previous embodiment of FIG. 2 and any repetitive explanation concerning the above elements will be omitted.

In an embodiment, the second to fourth transistors T2′ to T4′ may be transistors of different type from the first transistor T1. That is, the first transistor T1 may be implemented as a first type transistor, and the second to fourth transistors T2′ to T4′ may be implemented as second type transistors.

For example, the first transistor T1 may be implemented as the PMOS transistor, and the second to fourth transistors T2′ to T4′ may be implemented as the NMOS transistors.

When the first transistor T1 is implemented as the PMOS transistor, the driving current generated by the first transistor T1 may be increased compared to when it is implemented as the NMOS transistor. As the driving current generated by the first transistor T1 is increased, the stability of the pixel circuit PX′ may be increased.

When the second to fourth transistors T2′ to T4′ are implemented as the NMOS transistors, leakage currents of the second to fourth transistors T2′ to T4′ may be decreased compared to when those are implemented as the PMOS transistors. Accordingly, the stability of the pixel circuit PX′ may be increased.

For example, when the first transistor T1 is the PMOS transistor and the second to fourth transistors T2′ to T4′ are implemented as the NMOS transistors, the second to fourth transistors T2′ to T4′ may be disposed on a different layer than the first transistor T1. An area, which is occupied by a single pixel circuit PX′ in the display panel 100 when the second to fourth transistors T2′ to T4′ are disposed on the different layer than the first transistor T1, may be less than an area occupied by the single pixel circuit PX′ on the display panel 100 when the first to fourth transistors T1 to T4′ are disposed on the same layer. That is, as the area, which is occupied by a single transistor PX′ in the display panel 100 when the second to fourth transistors T2′ to T4′ are disposed on the different layer than the first transistor T1, is decreased, an integration density of the pixel circuit PX′ may be increased. As the integration density of the pixel circuit PX′ is increased, the display device 1 may have the high PPI and the high resolution. Accordingly, the display quality of the display device 1 may be improved.

Referring to FIG. 11, periods in which the pixel circuit PX operates may include a first period P1′, a second period P2′, a third period P3′, a fourth period P4′, and a fifth period P5′. The timing diagram is substantially the same as the timing diagram of FIG. 4 except for an activation level of a compensation gate signal GC′, a deactivation level of the compensation gate signal GC′, an activation level of an initialization gate signal GI′, a deactivation level of the initialization gate signal GI′, an activation level of writing gate signals GW[1]′-GW[m]′, and a deactivation level of the writing gate signals GW[1]′-GW[m]′. Thus, the same reference numerals will be used to refer to the same or like parts as those described in the previous embodiment of FIG. 4 and any repetitive explanation concerning the above elements will be omitted.

In an embodiment, as the first transistor T1 is implemented as the PMOS transistor and the second to fourth transistors T2′ to T4′ are implemented as the NMOS transistors, the activation level of the compensation gate signal GC′ may be the high level and the deactivation level of the compensation gate signal GC′ may be the low level. In addition, the activation level of the initialization gate signal GI′ may be the high level and the deactivation level of the initialization gate signal GI′ may be the low level. In addition, the activation level of the writing gate signals GW[1]′-GW[m]′ may be the high level and the deactivation level of the writing gate signals GW[1]′-GW[m]′ may be the low level.

The number of the transistors and the number of the capacitors included in the pixel circuit PX′ may be decreased compared to the conventional pixel circuit including five or more transistors and one or more capacitors. As the number of the transistors and the number of the capacitors included in the pixel circuit PX′ are decreased, the area occupied by the single pixel circuit PX′ on the display panel 100 may be decreased. As the area occupied by the single pixel circuit PX′ on the display panel 100 is decreased, the integration density of the pixel circuit PX′ may be increased. As the integration density of the pixel circuit PX′ is increased, the display device 1 may have the high PPI and the high resolution. Accordingly, the display quality of the display device 1 may be improved.

In addition, the third transistor T3′ may diode-connect the first node N1 and the second node N2 in response to the compensation gate signal GC′ having the activation level in the second period P2′. The threshold voltage of the first transistor T1 may be compensated for by the diode-connection. As the threshold voltage of the first transistor T1 is compensated for by the diode-connection, the threshold voltage of the first transistor T1 may be accurately compensated for regardless of the degradation of the parasitic capacitor of the light emitting element EE. That is, even if the parasitic capacitor of the light emitting element EE is degraded, the threshold voltage of the first transistor T1 may be accurately compensated for. As the threshold voltage of the first transistor T1 is accurately compensated for, the pixel circuit PX′ may emit a light at an accurate target luminance. Accordingly, the display quality of the display device 1 may be improved.

As the pixel circuits PX′ simultaneously receive the compensation gate signal GC′ through the first global signal line GSL1 (see FIG. 3A), an additional scan driver for generating and outputting the compensation gate signal GC′ which is differently provided for each pixel row may be not required. In addition, as the pixel circuits PX′ simultaneously receive the initialization gate signal GI′ through the second global signal line GSL2 (see FIG. 3A), an additional scan driver for generating and outputting the initialization gate signal GI′ which is differently provided for each pixel row may be not required. As the additional scan drivers are not required, the dead space and the power consumption of the display device 1 may be decreased. In addition, as the dead space of the display device 1 is decreased, the number of the pixel circuits PX′ included in the display panel 100 may be increased. That is, the integration density of the pixel circuit PX′ may be increased. As the integration density of the pixel circuit PX′ is increased, the display device 1 may have the high PPI and the high resolution. Accordingly, the display quality of the display device 1 may be improved.

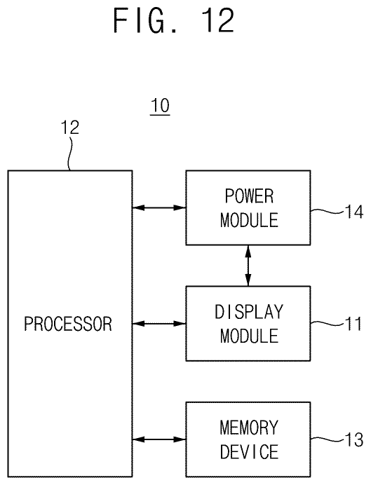

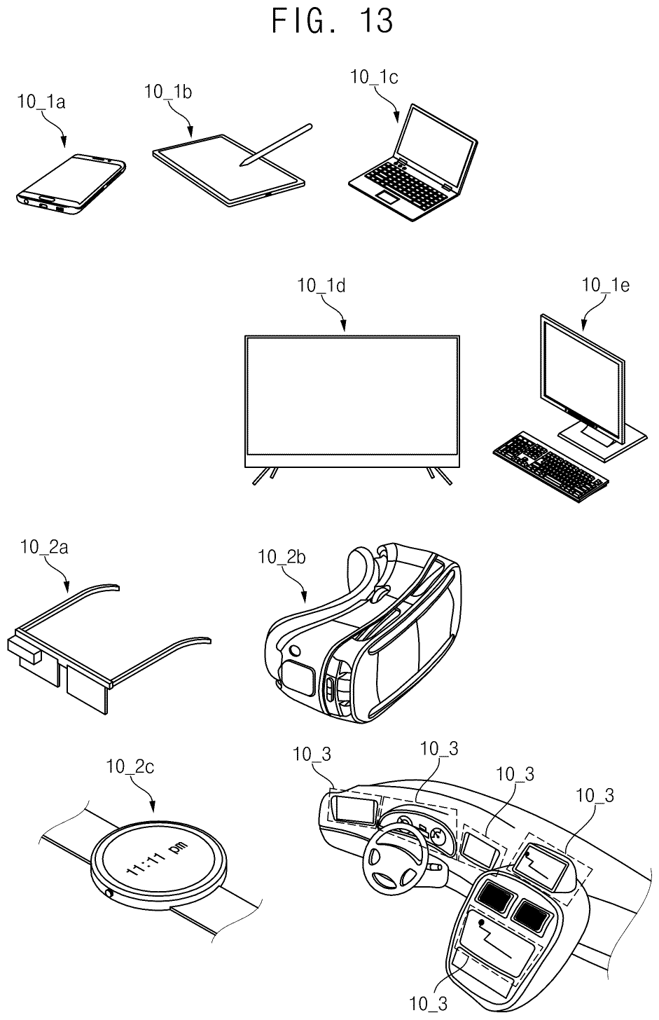

FIG. 12 is a block diagram illustrating an electronic device 10 according to embodiments. FIG. 13 is a schematic diagram illustrating the electronic device 10 of FIG. 12.

Referring to FIG. 12, the electronic device 10 may include a display module 11, a processor 12, a memory device 13, and a power module 14.

The display device 1 may be applied to various electronic devices. In an embodiment, the electronic device 10 may include the display device 1 of FIG. 1. In an embodiment, an operation of the display device 1 included in the electronic device 10 may be the same as an operation of the display device 1 described with reference FIGS. 1 to 9. In an embodiment, an operation of the display device 1 included in the electronic device 10 may be the same as an operation of the display device 1 described with reference FIGS. 10 and 11. In an embodiment, the electronic device 10 may further include modules or devices having other additional functions in addition to the display device 1.

The processor 12 may include at least one of a central processing unit (CPU), an application processor (AP), a graphic processing unit (GPU), a communication processor (CP), an image signal processor (ISP), and controller. The processor 12 may include one or more processors.

In an embodiment, the processor 12 may provide the input control signal CONT of FIG. 1 and the input image data IMG of FIG. 1 to the driving controller 200 included in the display device 1 of FIG. 1.

In an embodiment, the processor 12 may be provided as two or more forms in terms of functionality or structure. For example, the processor 12 may include a main processor in the form of a first driving chip including the central processing unit and an auxiliary processor in the form of a second driving chip including the controller that receives an image signal from the main processor and processes the image signal to conform interface specifications of the display module 11. The auxiliary processor may include the driving controller 200 included in the display device 1 of FIG. 1. Accordingly, the main processor may provide the input control signal CONT of FIG. 1 and the input image data IMG of FIG. 1 to the auxiliary processor. The auxiliary processor may process the image signal based on the input control signal CONT and the input image data IMG.

The memory device 13 may include at least one of a non-volatile memory device and a volatile memory device. Data information for an operation of the display module 11 or the processor 12 may be stored in the memory device 13. When the processor 12 executes an application stored in the memory device 13, the input control signal CONT and/or the input image data IMG may be transmitted to the display module 11. The display module 11 may process the input control signal CONT and/or the input image data IMG provided from the processor 12 and may output image information through the display panel.

The power module 13 may include a power supply module, such as a power adapter or a battery device, and a power conversion module that converts power supplied by the power supply module and generates power required for the operation of the electronic device 10.

At least one of the components of the electronic device 10 may be included in the display device 1. In addition, some of individual modules functionally included in one module may be included in the display device 1 and others may be provided separately from the display device 1. For example, the display device 1 may include the display module 11, and the processor 12, the memory device 13, and the power module 14 may be provided in the form of other devices in the electronic device 10, other than the display device 1.

Referring to FIG. 13, the various electronic devices having the display device 1 may include an image display electronic device such as a smart phone 10_1a, a tablet PC 10_1b, a laptop computer 10_1c, a TV 10_1d, a desk monitor 10_1e, and the like. In addition, the various electronic devices may include a wearable electronic device including the display module such as smart glasses 10_2a, a head mounted display 10_2b, a smart watch 10_2c, and the like. In addition, the various electronic device may include a vehicle electronic device 10_3 including the display module, such as an instrument panel, a center fascia, a center information display (CID) on a dashboard, a room mirror display, and the like. The electronic device 10 is not limited to the image display electronic device, the wearable electronic device and the vehicle electronic device 10_3.

In an embodiment, the display device 1 included in the electronic device 10 may include the display panel 100. The display panel 100 may include the pixel circuit PX. The pixel circuit PX may include the first to fourth transistors T1 to T4, the holding capacitor CHOLD and light emitting element EE.

The number of the transistors and the number of the capacitors included in the pixel circuit PX may be decreased compared to the conventional pixel circuit including five or more transistors and one or more capacitors. As the number of the transistors and the number of the capacitors included in the pixel circuit PX are decreased, the area occupied by the single pixel circuit PX on the display panel 100 may be decreased. As the area occupied by the single pixel circuit PX on the display panel 100 is decreased, the integration density of the pixel circuit PX may be increased. As the integration density of the pixel circuit PX is increased, the display device 1 may have the high PPI and the high resolution. Accordingly, the display quality of the display device 1 may be improved.

In addition, the third transistor T3 may diode-connect the first node N1 and the second node N2 in response to the compensation gate signal having the activation level. The threshold voltage of the first transistor T1 may be compensated for by the diode-connection. As the threshold voltage of the first transistor T1 is compensated for by the diode-connection, the threshold voltage of the first transistor T1 may be accurately compensated for regardless of the degradation of the parasitic capacitor of the light emitting element EE. That is, even if the parasitic capacitor of the light emitting element EE is degraded, the threshold voltage of the first transistor T1 may be accurately compensated for. As the threshold voltage of the first transistor T1 is accurately compensated for, the pixel circuit PX may emit a light at an accurate target luminance. Accordingly, the display quality of the display device 1 may be improved.

As the pixel circuits PX simultaneously receive the compensation gate signal GC through the first global signal line GSL1, the additional scan driver for generating and outputting the compensation gate signal GC which is differently provided for each pixel row may be not required. In addition, as the pixel circuits PX simultaneously receive the initialization gate signal GI through the second global signal line GSL2, the additional scan driver for generating and outputting the initialization gate signal GI which is differently provided for each pixel row may be not required. As the additional scan drivers are not required, the dead space and the power consumption of the display device 1 may be decreased. In addition, as the dead space of the display device 1 is decreased, the number of the pixel circuits PX included in the display panel 100 may be increased. That is, the integration density of the pixel circuit PX may be increased. As the integration density of the pixel circuit PX is increased, the display device 1 may have the high PPI and the high resolution. Accordingly, the display quality of the display device 1 may be improved.

The present disclosures may be applied to a display device and an electronic device including the display device. For example, the present disclosures may be applied to a television (TV), a digital TV, a 3D TV, a mobile phone, a smart phone, a tablet computer, a laptop computer, a personal computer (PC), a household electronic device, a personal digital assistant (PDA), a portable multimedia player (PMP), a digital camera, a music player, a portable game console, a navigation device, etc.

The foregoing is illustrative of the present disclosure and is not to be construed as limiting thereof. Although a few embodiments of the present disclosure have been described, those skilled in the art will readily appreciate that many modifications are possible in the embodiments without materially departing from the novel teachings and advantages of the present disclosure. Accordingly, all such modifications are intended to be included within the scope of the present disclosure as defined in the claims. In the claims, means-plus-function clauses are intended to cover the structures described herein as performing the recited function and not only structural equivalents but also equivalent structures. Therefore, it is to be understood that the foregoing is illustrative of the present disclosure and is not to be construed as limited to the specific embodiments disclosed, and that modifications to the disclosed embodiments, as well as other embodiments, are intended to be included within the scope of the appended claims. The present disclosure is defined by the following claims, with equivalents of the claims to be included therein.

What is claimed is:

1. A pixel circuit comprising:
a first transistor including a control electrode connected to a first node, a first electrode configured to receive a first power supply voltage, and a second electrode connected to a second node;
a second transistor including a control electrode configured to receive a writing gate signal, a first electrode configured to receive a data voltage, and a second electrode connected to a third node;
a third transistor including a control electrode configured to receive a compensation gate signal, a first electrode connected to the first node, and a second electrode connected to the second node;
a fourth transistor including a control electrode configured to receive an initialization gate signal, a first electrode connected to the second node, and a second electrode configured to receive an initialization voltage;
a holding capacitor including a first electrode connected to the third node and a second electrode connected to the first node; and
a light emitting element including an anode connected to the second node and a cathode configured to receive a second power supply voltage.

2. The pixel circuit of claim 1, wherein the pixel circuit is configured to operate sequentially in a first period for initializing the first node, the second node, and the third node, in a second period for compensating for a threshold voltage of the first transistor, in a third period for transmitting the data voltage to the third node, in a fourth period for initializing the anode of the light emitting element, and in a fifth period for allowing the light emitting element to emit a light at a luminance corresponding to the data voltage.

3. The pixel circuit of claim 2, wherein in the first period, the writing gate signal has an activation level, the compensation gate signal has an activation level, the initialization gate signal has an activation level, the data voltage has a first data voltage level, and the first power supply voltage applied to the first transistor has a first power supply voltage level.

4. The pixel circuit of claim 3, wherein in the second period, the writing gate signal has the activation level, the compensation gate signal has the activation level, the initialization gate signal has a deactivation level, the data voltage has the first data voltage level, and the first power supply voltage has a second power supply voltage level higher than the first power supply voltage level.

5. The pixel circuit of claim 4, wherein the data voltage having the first data voltage level corresponds to a minimum grayscale.

6. The pixel circuit of claim 4, wherein in the third period, the writing gate signal has the activation level, the compensation gate signal has the activation level, the initialization gate signal has the deactivation level, the data voltage has a second data voltage level corresponding to a target luminance, and the first power supply voltage has the second power supply voltage level.

7. The pixel circuit of claim 6, wherein in the fourth period, the writing gate signal has a deactivation level, the compensation gate signal has a deactivation level, the initialization gate signal has the activation level, the data voltage has a third data voltage level, and the first power supply voltage has the second power supply voltage level.

8. The pixel circuit of claim 7, wherein in the fifth period, the writing gate signal has the activation level, the compensation gate signal has the deactivation level, the initialization gate signal has the deactivation level, the data voltage has the third data voltage level, and the first power supply voltage has the second power supply voltage level.

9. The pixel circuit of claim 8, wherein the data voltage having the third data voltage level is a reference voltage.

10. A display device comprising:
a display panel including a pixel circuit; and
a display panel driver configured to drive the display panel,
wherein the pixel circuit includes:
a first transistor including a control electrode connected to a first node, a first electrode configured to receive a first power supply voltage, and a second electrode connected to a second node;
a second transistor including a control electrode configured to receive a writing gate signal, a first electrode configured to receive a data voltage, and a second electrode connected to a third node;
a third transistor including a control electrode configured to receive a compensation gate signal, a first electrode connected to the first node, and a second electrode connected to the second node;
a fourth transistor including a control electrode configured to receive an initialization gate signal, a first electrode connected to the second node, and a second electrode configured to receive an initialization voltage;
a holding capacitor including a first electrode connected to the third node and a second electrode connected to the first node; and
a light emitting element including an anode connected to the second node and a cathode configured to receive a second power supply voltage.

11. The display device of claim 10, wherein the pixel circuit is configured to operate sequentially in a first period for initializing the first node, the second node, and the third node, in a second period for compensating for a threshold voltage of the first transistor, in a third period for transmitting the data voltage to the third node, in a fourth period for initializing the anode of the light emitting element, and in a fifth period for allowing the light emitting element to emit a light at a luminance corresponding to the data voltage.

12. The display device of claim 11, wherein in the first period, the writing gate signal has an activation level, the compensation gate signal has an activation level, the initialization gate signal has an activation level, the data voltage has a first data voltage level, and the first power supply voltage applied to the first transistor has a first power supply voltage level.

13. The display device of claim 12, wherein in the second period, the writing gate signal has the activation level, the compensation gate signal has the activation level, the initialization gate signal has a deactivation level, the data voltage has the first data voltage level, and the first power supply voltage has a second power supply voltage level higher than the first power supply voltage level.

14. The display device of claim 13, wherein in the third period, the writing gate signal has the activation level, the compensation gate signal has the activation level, the initialization gate signal has the deactivation level, the data voltage has a second data voltage level corresponding to a target luminance, and the first power supply voltage has the second power supply voltage level.

15. The display device of claim 14, wherein in the fourth period, the writing gate signal has a deactivation level, the compensation gate signal has a deactivation level, the initialization gate signal has the activation level, the data voltage has a third data voltage level, and the first power supply voltage has the second power supply voltage level.

16. The display device of claim 15, wherein in the fifth period, the writing gate signal has the activation level, the compensation gate signal has the deactivation level, the initialization gate signal has the deactivation level, the data voltage has the third data voltage level, and the first power supply voltage has the second power supply voltage level.

17. The display device of claim 10, wherein pixel circuits including the pixel circuit included in the display panel are connected in common to a first global signal line, and
wherein the pixel circuits are configured to simultaneously receive the compensation gate signal through the first global signal line.

18. The display device of claim 10, wherein the pixel circuits included in the display panel are connected in common to a second global signal line, and
wherein the pixel circuits are configured to simultaneously receive the initialization gate signal through the second global signal line.

19. An electronic device comprising:
one or more processors configured to provide an input control signal and input image data;
a memory device configured to store data information for an operation of the one or more processors;
a display panel including a pixel circuit; and
a display panel driver configured to drive the display panel based on the input control signal and the input image data,
wherein the pixel circuit includes:
a first transistor including a control electrode connected to a first node, a first electrode configured to receive a first power supply voltage, and a second electrode connected to a second node;
a second transistor including a control electrode configured to receive a writing gate signal, a first electrode configured to receive a data voltage, and a second electrode connected to a third node;
a third transistor including a control electrode configured to receive a compensation gate signal, a first electrode connected to the first node, and a second electrode connected to the second node;
a fourth transistor including a control electrode configured to receive an initialization gate signal, a first electrode connected to the second node, and a second electrode configured to receive an initialization voltage;
a holding capacitor including a first electrode connected to the third node and a second electrode connected to the first node; and
a light emitting element including an anode connected to the second node and a cathode configured to receive a second power supply voltage.

20. The electronic device of claim 19, wherein pixel circuits including the pixel circuit included in the display panel are connected in common to a first global signal line,
wherein the pixel circuits are configured to simultaneously receive the compensation gate signal through the first global signal line,
wherein the pixel circuits are connected in common to a second global signal line, and
wherein the pixel circuits are configured to simultaneously receive the initialization gate signal through the second global signal line.
